(19) United States
(12) Patent Application Publication
(10) Pub. No.: US 2012/0325582 A1
(43) Pub. Date: Dec. 27, 2012

(54) FIRE SERVICE ELEVATOR

(76) Inventor: Hanspeter Bloch, Buchrain (CH)

(21) Appl. No.: 13/530,670

(22) Filed: Jun. 22, 2012

(30) Foreign Application Priority Data
Jun. 22, 2011 (EP) 11171052.1

(51) Int. Cl. B66B 11/02; B66B 13/00

(52) U.S. Cl. 182/129; 187/401

(57) ABSTRACT

A fire service elevator includes an elevator cage with a cage roof, a first side wall and a second side wall. The elevator cage is at least partly supported and driven by at least one support. The elevator cage is looped under by at least one support so that the at least one support runs along the two opposite side walls. The fire service elevator is designed so that the elevator cage in an operating state reaches speeds of more than 1 meter per second. The elevator cage includes at least one protective element which is arranged substantially above a side wall so that extinguishing water falling onto the cage roof in the case of fire is substantially prevented from wetting the at least one support means.

### CROSS-REFERENCE TO RELATED APPLICATION

This application claims priority to European Patent Application No. 11171052.1, filed Jun. 22, 2011, which is incorporated herein by reference.

### FIELD

The present disclosure relates to a fire service elevator.

### BACKGROUND

Modern elevator installations or so-called fire service elevators, which are designed additionally for this purpose, attempt to ensure reliable operation even in the case of fire. On the one hand evacuation of persons and/or material, which is at risk, from the stories affected by the fire should be ensured and on the other hand a functionally capable elevator also should be available for the transport of fire service personnel and their extinguishing material. In both cases the use of extinguishing water should not have the consequence that the elevator installation or the fire service elevator no longer functions. This applies not only to the use of a sprinkler installation on a story, but also to the use of extinguishing water by the fire service.

This usually means that electric components of the elevator installation should remain dry. Moreover, it should be ensured that a support means is still driven as intended on a drive pulley. Extinguishing water can in that case negatively influence the traction of the support means on the drive pulley. On the one hand, extinguishing water can directly reduce the coefficients of friction between the drive pulley and the support means and on the other hand lubricant present in the extinguishing water can in addition negatively influence the traction between the support means and the drive pulley. A support means wetted by extinguishing water can thus lead to a reduction of traction or even to a complete loss of traction. Particularly in the case of a substantial difference between the weight of the elevator cage and a counterweight an uncontrolled travel of the elevator cage can in that case arise, which should be stopped by safety brakes.

The use of belt-like support means instead of steel cables can have the problem of additionally emphasizing the loss of traction between support means and drive pulley. In the case of wetting by extinguishing water the synthetic material surfaces of belt-like support means change their traction characteristics more strongly than support means of steel cable form. This can make it necessary to conduct away the extinguishing water in controlled manner or to catch it. It can be necessary to prevent traction means sections which co-operate with the drive pulley from being wetted by extinguishing water.

The extinguishing water normally penetrates over the shaft doors of the elevator shaft into the elevator shaft. In that case the extinguishing water flows onto a story floor below the shaft doors through into the elevator shaft. In some cases, an elevator installation has a drainage system at the shaft doors as well as mechanically positively interengaging flow barriers at each shaft door. In this way it is sought to keep the elevator shaft free from extinguishing water over its entire height at the outset. However, it can be that each story has to be equipped at high cost with appropriate drain pipes and the said flow barriers.

### SUMMARY

In some embodiments, a fire service elevator comprises an elevator cage comprising a cage roof, a first side wall and a second side wall. The elevator cage is at least partly supported and driven by at least one support means. The elevator cage is looped under by the at least one support means, so that the at least one support means runs along the two opposite side walls. The fire service elevator is designed so that the elevator cage in an operational state reaches speeds of more than 1 meter per second. The elevator cage comprises at least one protective element, which is arranged substantially above a side wall, so that extinguishing water falling onto the cage roof in the case of fire is substantially prevented from wetting the at least one support means.

This solution consists in arranging a drain system at the outset not at the individual shaft doors, but at the elevator cage itself. This basic concept derives from recognition that the extinguishing water does not in principle have to be kept away from the elevator shaft, but can also flow away in controlled or deflected manner. It was observed that a main reason for the support means becoming wet is the spraying or atomization of the extinguishing water when impinging on the roof of the elevator cage.

The fire service elevator is designed so that the elevator cage in an operating state reaches speeds of more than 1 meter per second. This can mean that, in the case of fire, rescue maneuvers can be carried out efficiently and quickly. In some embodiments, the elevator cage in an operating state reaches speeds of more than 2 meters per second, possibly more than 3 meters per second.

For fire service elevators which are designed for very high speeds of the elevator cage it can be necessary to adapt the protective element to the more rapid relative air movements. In that case the protective element can be constructed, for example, to be more robust and/or stiffer than in the case of fire service elevators designed merely for lower speeds.

In further embodiments the elevator cage additionally comprises a ladder. In some embodiments the ladder is arranged at a cage back wall. A ladder being arranged outside the elevator cage can mean that rescue work outside the elevator cage in the case of fire is simplified.

In further embodiments, a balustrade is arranged substantially above at least one side wall of the elevator cage. In additional embodiments the balustrade is arranged substantially above both side walls.

In some embodiments the balustrade does not project above the at least one protective element. This can mean that movement of the elevator cage in the direction of the shaft ceiling is not restricted by the protective element.

In further embodiments the protective element is an independent component which, for example, can be fastened on the cage roof. In additional embodiments such a protective element is constructed from sheet metal. Fastening of the protective element can be carried out in various ways depending on the respective configuration of the elevator cage. It is, for example, also possible to fasten the protective element to a cage side wall so that the protective element extends above the cage roof in a plane of the cage side wall.

In an alternative form of embodiment the at least one protective element is fastened to the balustrade. This can mean that an independent fastening to the elevator cage does not have to be constructed for the protective element. In addition, the protective element can thus be clamped to the balustrade and therefore does not have to be made from a stiff material. For example, such a protective element clamped to the balustrade can be formed from a synthetic material foil which is sufficiently strong in order stop extinguishing water spraying from the cage roof against the support means.

In additional embodiments, the balustrade comprises an upper rail and a lower rail. In that case the upper rail can be set back above the first side wall in the direction of the second side wall. This can mean that the upper rail does not prevent over-travel of the elevator cage above a drive which is arranged substantially above the first side wall. Possibly, in that case the at least one protective element above the first side wall does not project above the lower rail of the balustrade. It can thus be ensured that the protective element does not additionally obstruct over-travel of the elevator cage beyond the drive.

In some cases, modifications or constructional measures do not have to be undertaken either at the elevator itself or at the elevator shaft. The proposed protective element can, for example, also be retrofitted to existing elevator installations in simple mode and manner. Moreover, this proposed solution can be economic.

In further embodiments, elevator cages of different types can be retrofitted. The protective element can be arranged on any of planar, chamfered and even irregularly shaped cage roofs. This can enable retrofitting of the extinguishing water deflecting system to almost all elevator types. The protective element can thus be interpreted as an additional component which can be arranged on existing, intrinsically closed elevator cages.

In some cases, the protective element is used in fire service elevators which have support means with a synthetic material casing, such as, for example, belts. The protective element can equally well be used with support means without synthetic material encasing, such as, for example, steel cables, but here the traction loss due to wetting of the support means by extinguishing water is usually less serious than in the case of support means encased by synthetic material. Such belts usually have a casing of synthetic material arranged around a plurality of tensile carriers disposed parallel to one another. The tensile carriers can be constructed from, for example, steel wires or synthetic fibers.

In some cases, two protective elements are provided, wherein in each instance a first protective element is arranged substantially above a first cage side wall and a second protective element is arranged substantially above a second cage side wall. This can mean that the at least one support means is completely protected from the extinguishing water falling on the cage roof in the case of fire.

Several support means extending parallel to one another can be arranged, wherein each of these support means loops under the elevator cage. Each of the parallel extending support means runs along the opposite side walls of the elevator cage.

So as not to limit travel of the elevator cage in the direction of the shaft head, the protective element is possibly constructed in such a manner that in a use state it does not project above other components of the elevator cage. The height of the protective element is, for example, 20 centimeters to 120 centimeters.

The protective element can in principle be made from various kinds of materials. The protective element possibly consists of an economic, robust and light material which can be shaped or produced by simple methods. An example of such a material is sheet metal. Alternatively thereto, for example, use can also be made of different synthetic materials. The wall thickness of the protective element is, for example, possibly between 0.5 millimeters and 30 millimeters, possibly between 1 millimeter and 10 millimeters, possibly between 1 millimeter and 7 millimeters.

The protective element can be shaped in various ways. One form is a rectangular element which extends substantially along the entire side wall of the elevator cage. However, other shapes are also usable. For example, use can also be made of beveled or irregularly shaped elements. It can be important for the selection of the shape that the support means is effectively screened by the protective element from spray water sprayed from the cage roof in the direction of the support means.

Fire service elevators are elevators which have special adaptations so that they can remain capable of use longer in the case of fire. Such adaptations are, for example, electronic components protected against spray water, fireproof cage elements or a specific control mode for the case of fire. The protective element is similarly such an adaptation. In this sense, any elevator which is equipped with such a protective element is termed a fire service elevator in the following.

### BRIEF DESCRIPTION OF THE DRAWINGS

The disclosed technologies are explained in more detail symbolically and by way of example by way of figures, in which:

FIG. 1 shows a schematic illustration of an exemplifying elevator installation in a building with a fire extinguishing installation;

FIG. 2 shows an exemplifying form of embodiment of an elevator cage with protective element;

FIG. 3 shows an exemplifying form of embodiment of an elevator cage with protective element; and

FIG. 4 shows an exemplifying form of embodiment of an elevator cage with a protective element.

### DETAILED DESCRIPTION

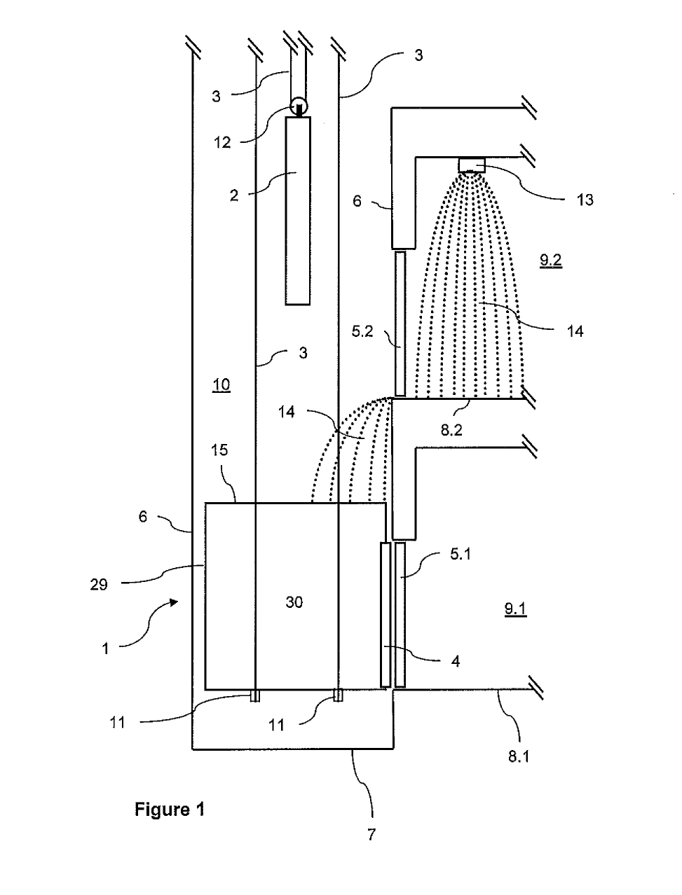

FIG. 1 shows an elevator installation such as is known from the prior art. A cage 1 and a counterweight 2 are arranged in an elevator shaft 10. In that case, both the elevator cage 1 and the counterweight 2 are coupled with a support means 3. The elevator cage 1 and the counterweight 2 can be vertically moved in the shaft 10 by driving the support means 3 by a drive (not illustrated). In the illustrated exemplifying embodiment not only the elevator cage 1, but also the counterweight 2 are suspended at support rollers 11, 12. The cage support rollers 11 are in that case arranged below the cage 1 so that the cage 1 is looped under by the support means 3. By contrast thereto the counterweight support roller 12 is arranged above the counterweight 2 so that the counterweight 2 is suspended at the counterweight support roller 12. Through the looping-under of the elevator cage 1 the support means 3 is guided along cage side walls 30.

A shaft wall 6 has a respective opening at the height of each story 9.1, 9.2, which opening can be closed by a respective shaft door 5.1, 5.2. A fire extinguishing installation 13 is installed on the second-lowermost story 9.2. The fire extinguishing installation 13 is arranged at a ceiling of the story 9.2 so that extinguishing water 14 can reach the largest possible number of fire locations. The extinguishing water 14 collects on the story floor 8.2 and flows from there, at least partly, through under the shaft door 5.2 and into the elevator shaft 10. As illustrated in FIG. 1, the extinguishing water 14 flowing through the shaft door 5.2 can drop in the manner of a waterfall from above onto the elevator cage 1. From the elevator cage 1 the extinguishing water 14 flows further down until it collects at the shaft floor 7 (not illustrated).

The distribution of the extinguishing water 14 in the elevator shaft 10 is dependent on, inter alia, the following factors: For entry of the extinguishing water 14 into the elevator shaft 10 the extinguishing water quantity and also a gap size between the shaft door 5.2 and the story floor 8.2 are at the outset critical. The larger the quantity of extinguished water, the greater the water pressure which can shoot the extinguishing water into the shaft. The shape and size of the gap between the shaft door 5.2 and the story floor 8.2 have a direct influence on the distribution of the extinguishing water 14 in the elevator shaft 10. In addition, the distribution of the extinguishing water 14 in the elevator shaft 10 is influenced by the height difference between the elevator cage 1 and the story 9.2 from which the extinguishing water 14 penetrates into the shaft 10. The greater the spacing between a cage roof 15 and the story floor 8.2 from which the extinguishing water 14 penetrates into the shaft 10 the more rapidly the extinguishing water 14 falls onto the elevator cage roof 15 and the further the extinguishing water 14 is sprayed from the cage roof 15. A larger spacing between the cage roof 15 and the story floor 8.2 from which the extinguishing water penetrates into the shaft 10 additionally has the consequence that the extinguishing water can propagate more widely and deeply in the shaft 10 due to a higher drop path.

It is apparent from FIG. 1 that the extinguishing water 14 when impinging on the cage roof 15 is not, as far as possible, to be sprayed and that the extinguishing water 14 is diverted from the cage roof 15 over a cage door 4 or over a cage rear wall 29. Not only during spraying onto the cage roof 15, but also during running down at the cage side walls 30 there is the risk that the support means 13 is wetted by the extinguishing water 14.

It will be apparent that the principles and problems described with respect to FIG. 1 also occur with different kinds of fire extinguishing installations 13 and different kinds of elevators.

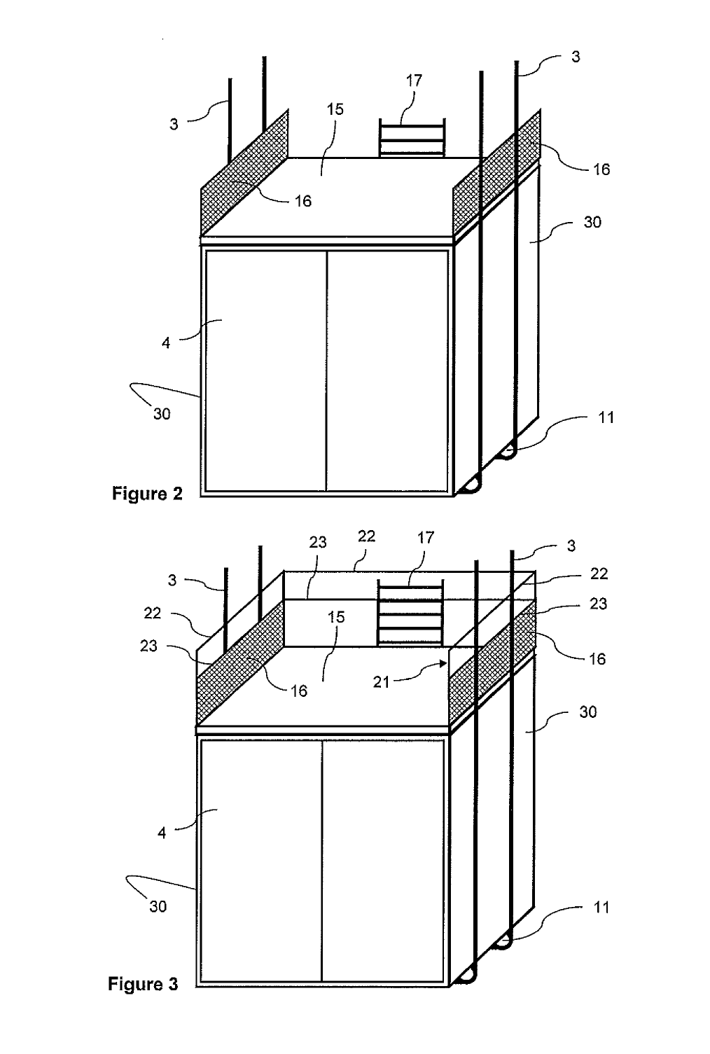

FIG. 2 shows an exemplifying form of embodiment of an elevator cage in three-dimensional illustration. The elevator cage is looped under by two support means 3, wherein the support means 3 are guided by guide rollers 11 around the elevator cage. The support means 3 are screened by two protective elements 16 from extinguishing water, which drops from above onto the cage roof 15 and is sprayed from there laterally.

The protective elements 16 in FIG. 2 are constructed as independent components. They have a rectangular form and extend substantially over the entire width of the side walls 30. In this form of embodiment the protective elements 16 are arranged in a plane of the side walls 30. The protective elements 16 can also be arranged slightly offset with respect to the plane of the side walls 30 without losing their function as spray protection walls for protection of the support means 3.

A ladder 17 is arranged at a back wall of the elevator cage. The ladder 17 serves to facilitate rescue activities in the elevator shaft outside the elevator cage in the case of a fire.

FIG. 3 shows a further exemplifying form of embodiment of an elevator cage in perspective illustration. The elevator cage is again looped under by two support means 3, wherein the support means 3 are guided by support rollers 11 round the elevator cage. In addition, a balustrade 21 is arranged on the cage roof 15. In this exemplifying embodiment the balustrade is arranged above the two side walls 30 and above the rear wall of the elevator cage. In that case the balustrade 21 comprises an upper rail 22 and a lower rail 23, which are interconnected. The upper rail 22 is disposed on a common plane above the cage roof 15 and the lower rail 23 is similarly disposed on a common plane above the cage roof 15, wherein the plane of the upper rail 22 lies above the plane of the lower rail 23.

Such a balustrade 21 serves for the safety of persons who execute repair or maintenance operations in the elevator shaft from the cage roof. In that case, the height of the balustrade 21 is usually oriented to the width of a gap present between the cage and the shaft walls. The larger the gap between the cage and the shaft walls the higher the balustrade 21 should be. Such heights of the balustrade 21 are usually fixed in safety standards.

In this exemplifying embodiment the protective elements 16 are fastened to the balustrade 21. A respective protective element 16 is again arranged above each side wall 30 of the elevator cage. The protective elements 16 each reach from the cage roof 15 up to the lower rails 23 of the balustrade 21. In other embodiments the protective elements 16 can reach up to the upper rails 22 of the balustrade 21 or up to a different height.

The protective elements 16 can be so constructed that they do not project above the balustrade 21. A movement of the elevator cage in the direction of the shaft head (not illustrated) is thereby not additionally restricted by the protective elements 16.

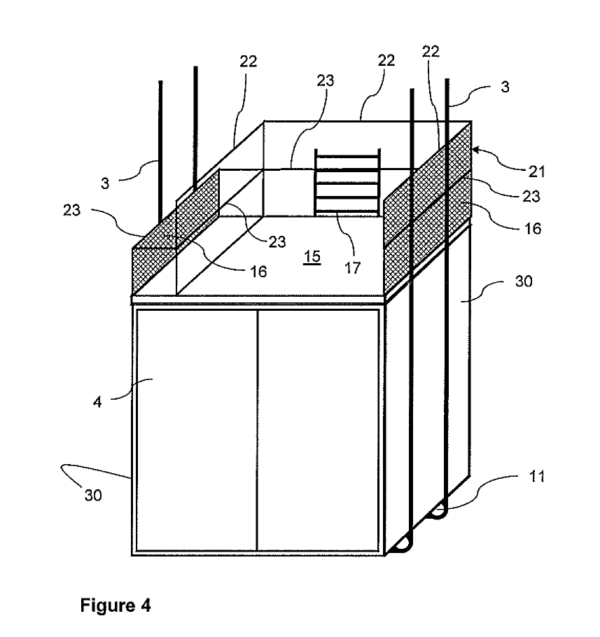

FIG. 4 shows a further exemplifying form of embodiment of an elevator cage in three-dimensional illustration. The elevator cage is again moved under by two support means 3, wherein the support means 3 is guided by support rollers 11 around the elevator cage.

A balustrade 21 is again arranged on the cage roof 15. The balustrade 21 in this exemplifying embodiment similarly comprises a lower rail 23 and an upper rail 22. The upper rail 22, which is disposed substantially above the first side wall 30, is set back in the direction of the second side wall 30. It is thereby achieved that the upper rail 22 does not prevent over-travel of the elevator cage beyond a drive (not illustrated) arranged substantially above the first side wall 30 in a shaft head.

In the case of a set-back upper rail 22 the protective element 16 can extend, as illustrated in FIG. 4, only up to the lower rail 23, which is not set back. It is thereby achieved that the protective element 16 is arranged as directly as possible above the side wall 30 so that the support means 3 running along the side wall 30 has best possible protection from extinguishing water spraying laterally onto the cage roof 15.

As illustrated in FIG. 4, use can indeed be made of two protective elements 16 which do not have the same shape, size or arrangement at the elevator cage. Depending on the respective cage type, use can therefore be made of different protective elements 16.

Having illustrated and described the principles of the disclosed technologies, it will be apparent to those skilled in the art that the disclosed embodiments can be modified in arrangement and detail without departing from such principles. In view of the many possible embodiments to which the principles of the disclosed technologies can be applied, it should be recognized that the illustrated embodiments are only examples of the technologies and should not be taken as limiting the scope of the invention. Rather, the scope of the invention is defined by the following claims and their equivalents. I therefore claim as my invention all that comes within the scope and spirit of these claims.

I claim:

1. A fire service elevator comprising:
an elevator cage disposed in a shaft, the elevator cage comprising a cage roof and opposing first and second side walls, the cage being configured to travel in the shaft faster than 1 meter per second; and
a support looped under the elevator cage and running along each of the first and second side walls, the elevator cage further comprising a protective element arranged substantially above the first side wall or the second side wall such the support is substantially shielded from water falling onto the cage roof.

2. The fire service elevator of claim 1, the elevator cage further comprising an exterior ladder.

3. The fire service elevator of claim 2, the elevator cage further comprising a cage back wall, the exterior ladder being arranged at the cage back wall.

4. The fire service elevator of claim 1, further comprising a balustrade arranged substantially above the first cage side wall or the second cage side wall.

5. The fire service elevator of claim 4, the balustrade being arranged substantially above both the first and second side walls.

6. The fire service elevator of claim 4, the protective element not projecting above the balustrade.

7. The fire service elevator of claim 4, the protective element being fastened to the balustrade.

8. The fire service elevator of claim 4, the balustrade comprising an upper rail and a lower rail, the upper rail being set back above the first side wall toward the second side wall such that the upper rail does not obstruct over-travel of the elevator cage beyond a drive arranged substantially above the first side wall.

9. The fire service elevator of claim 8, the protective element being arranged above the first side wall and not projecting above the lower rail of the balustrade.

10. The fire service elevator of claim 1, the protective element comprising a synthetic foil.

11. The fire service elevator of claim 1, the protective element comprising sheet metal.

12. The fire service elevator of claim 1, the protective element having a height between 20 centimeters and 120 centimeters.

13. The fire service elevator of claim 1, the protective element having a wall thickness between 1 millimeter and 10 millimeters.

14. The fire service elevator of claim 1, the protective element comprising a belt with at least two tensile carriers embedded in a synthetic material casing.

15. The fire service elevator of claim 1, the protective element being a first protective element, the elevator cage further comprising a second protective element, the first protective element being arranged substantially above the first side wall and the second protective element being arranged substantially above the second side wall.
